(19) United States
(12) Patent Application Publication
(10) Pub. No.: US 2021/0100174 A1
(43) Pub. Date: Apr. 8, 2021

(54) AGRICULTURAL MAT

(71) Applicant: Shinichiro ITOI, Saitama (JP)

(72) Inventor: Shinichiro ITOI, Saitama (JP)

(21) Appl. No.: 16/971,183

(22) PCT Filed: Mar. 6, 2018
(86) PCT No.: PCT/JP2018/008595

§ 371 Date: Aug. 19, 2020

(51) Int. Cl. A01G 13/00; A01G 7/06

(52) U.S. Cl. CPC A01G 13/00; A01C 21/005; A01G 7/06

(57) ABSTRACT

To keep down the costs required to prevent disease and insect pests when cultivating plants. This agricultural mat 1 comprises a bottom plate 2, a cover member 3 covering the bottom plate, a hole 3a penetrating the cover member in order for an internal space 4 formed by the bottom plate and the cover member to communicate with the outside, sulfur powder 5 accommodated in the internal space, and means 6 for the sulfur powder to be in contact with soil 10 when the bottom plate is placed on the soil. The means for sulfur powder to be in contact with the soil may be formed from an opening 2a formed in the bottom plate and a sheet of paper 7 covering the opening and having the sulfur powder placed thereon. A cup 8 may also be provided, which is configured such that while the sulfur powder is accommodated therein, an open bottom portion of the cup comes into contact with the paper, and which has a hole 8a to cause the space accommodating the sulfur powder to communicate with the internal space formed by the bottom plate and the cover member.

### CROSS-REFERENCE TO RELATED APPLICATIONS

The present application claims priority to International Application No. PCT/JP2018/008595 filed on Mar. 6, 2018, the disclosure of which is incorporated herein by reference.

### STATEMENT RE: FEDERALLY SPONSORED RESEARCH/DEVELOPMENT

Not Applicable

BACKGROUND

### 1. Technical Field of the Invention

The present invention relates to an agricultural mat for preventing disease and insect pests when cultivating plants.

### 2. Description of the Related Art

Various agrochemicals have been conventionally used to prevent disease and insect pests of plants, and more particularly of farm products. In addition, foliar spraying of fertilizer has been performed to enhance resistance of the farm products to disease and the like, and to early recover therefrom also.

### BRIEF SUMMARY

However, a large number of pests often generate in a short period of time, so that agrochemical splaying is frequently required to increase cost. In addition, there are pests and fungus with agrochemical resistance, so that plural kinds of agrochemicals are required.

Then, the present invention has been made in consideration of the above problems in the conventional plant cultivating method, and the object thereof is to provide an agricultural mat capable of suppressing costs for prevention against disease and insect pests when cultivating plants.

To attain the above object, an agricultural mat according to the present invention includes a bottom plate, a cover member covering the bottom plate, a hole penetrating the cover member in order for an internal space formed by the bottom plate and the cover member to communicate with an outside, sulfur powder accommodated in the internal space, and means for the sulfur powder to be in contact with soil when the bottom plate is placed on the soil.

With the present invention, contacting the sulfur powder with the soil allows amino acids such as methionine and alanine to be made in the soil, and sulfuric bacterial group in the soil enlarges sulfuric root area to enhance sterilizing power of the soil. The methionine and the alanine induce protein, and when the sulfur powder and the soil contact with each other for a long period of time, sulfur bacteria, and chlorobi chlorobium and purple bacteria chlorophyll carcinoid of sulfur compound inorganic of photosynthetic bacteria absorb light to generate sulfurous acid gas from the sulfur powder. The sulfurous acid gas is discharged through the hole penetrating the cover member, and is absorbed into leaves of seedlings, and strong smell of the sulfurous acid gas adhered to the leaves expels pests. Therefore, amounts and kinds of agrochemicals can be decreased by one third compared with conventional agrochemicals, and costs for prevention against disease and insect pests can be suppressed and agricultural work can be rationalized.

In the agricultural mat, the means for sulfur powder to be in contact with the soil may be formed from an opening formed in the bottom plate and a sheet of paper covering the opening and having the sulfur powder placed thereon. With this, just mounting the agricultural mat on the soil allows the paper to get wet to decrease strength, and the paper to be decomposed by the soil, which enables the sulfur powder to contact the soil.

On the agricultural mat, a cup may also be mounted. The cup is configured such that while the sulfur powder is accommodated therein, an open bottom portion of the cup comes into contact with the paper. In addition, the cup has a hole to cause the space accommodating the sulfur powder to communicate with the internal space formed by the bottom plate and the cover member. With this, while inside of the cup and outside of the agricultural mat are communicated with each other, the sulfur powder is held in a predetermined position in the agricultural mat.

As described above, with the present invention, it becomes possible to keep down the costs required to prevent disease and insect pests when cultivating plants.

### BRIEF DESCRIPTION OF THE DRAWINGS

FIG. 1 is a schematic view showing an agricultural mat according to an embodiment of the present invention, in which (a) is a longitudinally sectional view partially showing a sectional portion, (b) is a plan view, and (c) is a bottom plan view.

FIG. 2 is a schematic view showing installation example of the agricultural mat shown in FIG. 1.

FIG. 3 is a schematic view showing a reference example of a plant cultivating method.

### DETAILED DESCRIPTION

Next, an embodiment of the present invention will be explained with reference to the attached drawings.

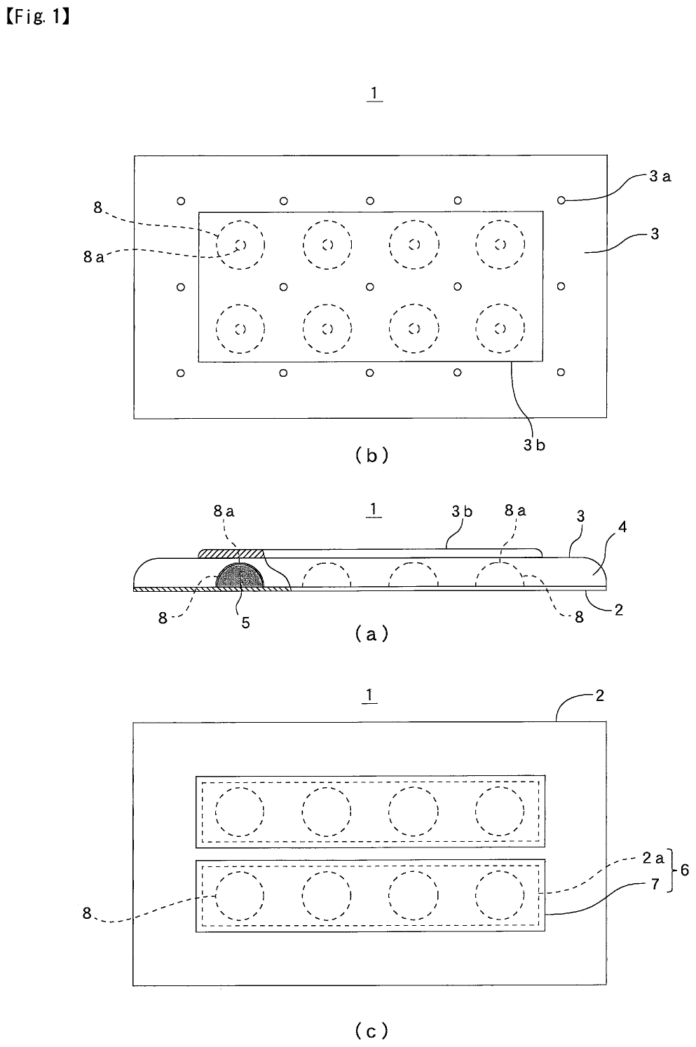

FIG. 1 shows an agricultural mat according to an embodiment of the present invention, and the agricultural mat 1 is provided with a bottom plate 2, a cover member 3 for covering the bottom plate 2, holes 3a penetrating the cover member 3 in order for an internal space 4 formed by the bottom plate 2 and the cover member 3 to communicate with the outside, sulfur powder 5 accommodated in the internal space 4, means for the sulfur powder 5 to be in contact with soil when the bottom plate 2 is placed on the soil (hereinafter, referred as “contact means”.) 6, and so on.

The bottom plate 2 is a rectangular plate having a short side of about 6cm and a long side of about 11cm, and is made of polyethylene or plastic such as vinyl. On the bottom plate 2 is drilled two rectangular openings 2a, and in the openings 2a are arranged the following four cups 7 in a line. The opening 2a is one element of the contact means 6.

The cover member 3 covers the upper surface of the bottom plate 2 while forming the internal space 4 with the bottom plate 2, and can be made from polyethylene or plastic such as vinyl. Number and arrangement of the holes 3a penetrating the cover member 3 can be a total of 15 (3 rows×5 columns) for instance. In addition, the cover member 3 is fixed to the bottom plate 2 with adhesive or the like.

The contact means 6 includes two openings 2a formed in the bottom plate 2 and two sheets of paper 7 covering the openings 2a, on the two sheets of paper 7 being placed the sulfur powder 5.

In addition, the agricultural mat 1 includes cups (whose diameter is about 1.2 cm) 8 that are configured such that while the sulfur powder 5 is accommodated therein, open bottom portions of the cups come into contact with the paper 7, and that have holes 8a to cause the space accommodating the sulfur powder 5 to communicate with the internal space 4 formed by the bottom plate 2 and the cover member 3. Four cups 8 are arranged for each opening 2a of the bottom plate 2, so that totally eight cups 8 are arranged. Although illustration is omitted, the sulfur powder 5 is accommodated every cup 8. With this, the following sulfurous acid gas can be discharged outside while maintaining the sulfur powder 5 in a predetermined position of the agricultural mat 1.

Further, forming a projecting reinforced part 3b on the upper surface of the cover member 3 enhances strength of the agricultural mat 1.

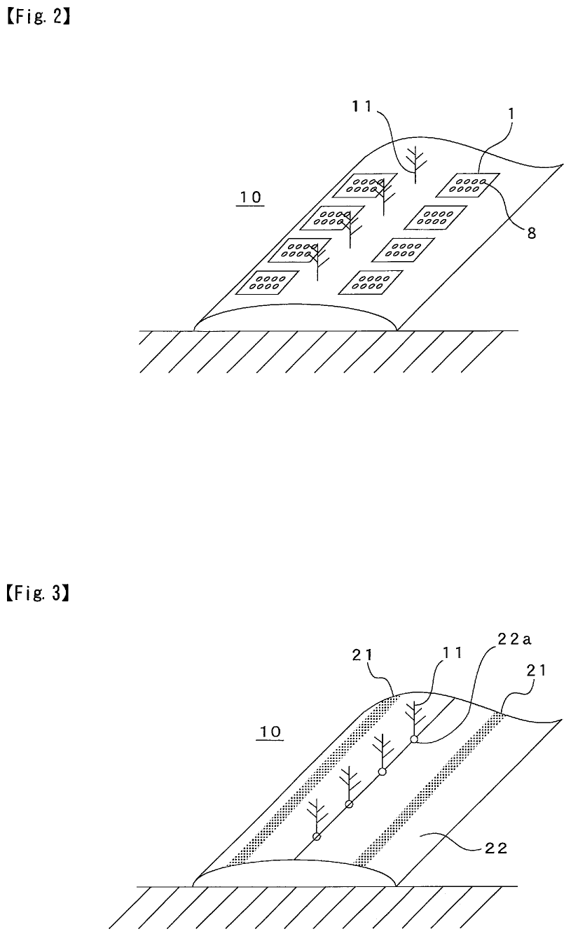

Next, an example of installation of the agricultural mat 1 with the above structure will be explained with reference to FIGS. 1 and 2.

To use the agricultural mat 1 according to the present invention, the agricultural mat 1 is arranged near a seedling 11 on soil 10. When the agricultural mat 1 is arranged on the soil 10, the paper 7 gets wet to decrease strength or is broken by the soil, and the sulfur powders 5 accommodated in the cups 8 contact the soil 10.

Contacting the sulfur powder 5 with the soil 10 causes amino acids such as methionine and alanine to be made in the soil 10, and sulfuric bacterial group in the soil enlarges sulfuric root area to enhance sterilizing power of the soil, and root disease of the seedling 11 such as anthracnose, powdery mildew and downy mildew can be prevented, and the root of the seedling 11 can be protected from insect pests by aphids and mites.

Then, when the sulfur powder 5 and the soil 10 contact with each other for a long time, the sulfur powder 5 generates sulfurous acid gas, and the sulfurous acid gas is discharged through the holes 8a of the cups 8 and the holes 3a of the cover member 3 from the upper portion of the agricultural mat 1 to the outside. The discharging sulfurous acid gas is absorbed into leaves of the seedling 11, and strong smell of the sulfurous acid gas adhered to the leaves expels pests, and particularly downy mildew, powdery mildew, sclerotal disease and brown spots can be prevented. Although more or equal to 85% of the sulfurous acid gas is absorbed into the seedling, the amount is small, so that the sulfurous acid gas has little effect on growth of the seedling 11 and others, human bodies of workers in a house and the like, and surrounding environments.

With the present invention, as described above, installing the agricultural mat 1 only can prevent disease and insect pests, so that the amount of agrochemicals can be decreased by one third compared with conventional agrochemicals, and kinds of agrochemicals can be reduced, resulting in decreased costs. The above effects continue for 150 days after the agricultural mat 1 is installed.

In addition, in the above explanation, the contact means 6 consists of the openings 2a of the bottom plate 2 and the sheets of paper 7, and the sulfur powder 5 automatically contacts the soil 10, but in order to contact the sulfur powder 5 with the soil 10 more quickly, instead of the paper 7 can be mounted slide members for opening or closing the openings 2a of the bottom plate 2. On the slide members is placed the sulfur powder 5, when the agricultural mat 1 is installed, sliding the slide members opens the openings 2a, which can manually contact the sulfur powder 5 with the soil 10.

In addition, forms, numbers and arrangements of the openings 2a penetrating the bottom plate 2 and the holes 3a penetrating the cover member 3 are just examples, and those can be properly changed depending on spreading state of the sulfurous acid gas or contacting state of the sulfur powder 5 and the soil 10.

Next, a reference example of a plant cultivating method will be explained with reference to FIG. 3.

In the plant cultivating method according to the present reference example, near the position of the soil 10 where the seedling 11 will be arranged, sulfur powder 21 is arranged in a line or in two lines (the two lines case is illustrated). Here, it is preferable that amount of the arranged sulfur powder 21 is about 15-50 kg per the soil 10a (are).

Next, after the soil 10 is covered with a sheet (covering member) 22 made of polypropylene or the like such that planting holes 22a position in a position separated by about 4-50 cm from the sulfur powder 21s arranged on the soil 10, the seedlings 11 are planted through the planting holes 22a.

With the present reference example, contacting the sulfur powders 21 with the soil 10 enhances sterilizing power of the soil, and prevents diseases of roots of the seedlings 11, and prevents insect pests of roots of the seedlings 11 in advance. In addition, sulfurous acid gas generated from the sulfur powder 21 expels pests. Therefore, so that the amount of agrochemicals can be decreased compared with conventional agrochemicals, and kinds of agrochemicals can be reduced, resulting in decreased costs.

### DESCRIPTION OF THE REFERENCE NUMERALS

1 agricultural mat
2 bottom plate
2a openings
3 cover member
3a holes
3b reinforced part
4 internal space
5 sulfur powder
6 contact means
7 paper
8 cups
8a holes
10 soil
11 seedlings
21 sulfur powder
22 sheet
22a planting holes

1. An agricultural mat comprising:
a bottom plate,
a cover member covering the bottom plate,
a hole penetrating the cover member in order for an internal space formed by the bottom plate and the cover member to communicate with an outside,
sulfur powder accommodated in the internal space, and
means for the sulfur powder to be in contact with soil when the bottom plate is placed on the soil.

2. The agricultural mat as claimed in claim 1, wherein the means for sulfur powder to be in contact with the soil is formed from an opening formed in the bottom plate and a sheet of paper covering the opening and having the sulfur powder placed thereon.

3. The agricultural mat as claimed in claim 2, further comprising a cup that is configured such that while the sulfur powder is accommodated therein, an open bottom portion of the cup comes into contact with the paper, and which has a hole to cause the space accommodating the sulfur powder to communicate with the internal space formed by the bottom plate and the cover member.
